(19) United States
(12) Patent Application Publication
(10) Pub. No.: US 2014/0297414 A1
(43) Pub. Date: Oct. 2, 2014

(54) ROUTINE SUGGESTION SYSTEM

(71) Applicants: Lucy Ma Zhao, Austin, TX (US); Kamal Zamer, Austin, TX (US)

(72) Inventors: Lucy Ma Zhao, Austin, TX (US); Kamal Zamer, Austin, TX (US)

(21) Appl. No.: 13/853,455

(22) Filed: Mar. 29, 2013

(51) Int. Cl. G06Q 30/02

(52) U.S. Cl. CPC G06Q 30/0259
USPC 705/14.57

(57) ABSTRACT

Systems and methods for providing routine suggestions include determining that a user is in a current location that is over a predetermined distance from a home location that is associated with the user in a non-transitory memory. A current time is then determined that corresponds to a time period associated with a routine purchase type that is associated with the home location in the non-transitory memory. At least one merchant is then retrieved over a network that is associated with the current location and that provides the routine purchase type. The at least one merchant is then displayed on a display device. The systems and methods operate to “learn” routine purchases made by the user in a home location, and then provide suggested merchants at which those routine purchases can be made when the user is in a location different from the home location.

### BACKGROUND

1. Field of the Invention

The present invention generally relates to online and/or mobile payments and more particularly to system that uses routine purchases in a first location to suggest merchants in a second location.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Consumers often make purchases, sometimes using online and/or mobile payments, at regular, reoccurring time periods. For example, a consumer may regularly purchase coffee during particular time periods (e.g., weekday mornings) at the same coffee merchant in their hometown, or may purchase the same type of coffee during particular time periods at a variety of coffee merchants in their hometown. In another example, a consumer may regularly dine at particular times (e.g., a particular day of the week) at the same restaurant in their hometown, or may dine during particular time periods at the same type of restaurant (e.g., a Italian restaurant) in their hometown. In yet another example, a consumer may regularly exercise at particular times (e.g., a particular day of the week) at the same exercise location in their hometown, and that consumer may then regularly follow that exercise with a particular purchase. Such routines may be disrupted when the consumer leaves their hometown for another location (e.g., due to business, vacation, etc), as the consumer may end up in an unfamiliar location where the time and effort necessary to find the appropriate merchants that will allow the performance of these routines discourages the consumer from doing so.

Thus, there is a need for a routine suggestion system that simplifies the ability of a user to perform their routines in an unfamiliar location.

### BRIEF DESCRIPTION OF THE FIGURES

FIG. 1 is a flow chart illustrating an embodiment of a method for providing routine suggestions;

FIG. 2 is a schematic view illustrating an embodiment of a routine suggestion system;

FIG. 3 is a is a front view illustrating a user device displaying a routine suggestion screen;

FIG. 4 is a is a front view illustrating a user device displaying a routine suggestion screen;

FIG. 5 is a front view illustrating a user device displaying a routine suggestion screen;

FIG. 6 is a is a front view illustrating a user device displaying a routine suggestion screen.

FIG. 7 is a schematic view illustrating an embodiment of a networked system;

FIG. 8 is a perspective view illustrating an embodiment of a user device;

FIG. 9 is a schematic view illustrating an embodiment of a computer system; and

FIG. 10 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing user routine suggestions. A user may generate routine data in a home location by making similar purchases in the same time periods. For example, a user may purchase food regularly from the same merchant during the same time period or time periods each week, or purchase the same type of item from different merchants during the same time period or time periods each week. Those purchases may be stored and analyzed to create routine data that is associated with the home location of the user and that may detail repetitive purchasing routines by the user by associating routine purchase types (e.g., purchases from a particular merchant, purchases from type of merchant, purchases of an item type, etc.) with particular time periods. When the user travels to a location (a “current location”) that is more than a predetermined distance from the home location, the systems and methods may determine that a current time corresponds to a time period associated with a routine purchase type and, in response, retrieve merchants that are located in the current location and that provide the routine purchase type associated with the time period. Those merchants may then be displayed on a user device to allow the user to quickly and easily determine a merchant in their current location (away from their home location) at which they may make their routine purchase. Routine data may associate routine purchase types with linked purchase types that are purchases commonly made by the user following a routine purchase type in the home location, and when such a routine purchase type is made in a location that is a predetermined distance from the home location, the systems and methods may retrieve merchants that are located in the current location and that provide the linked purchase types.

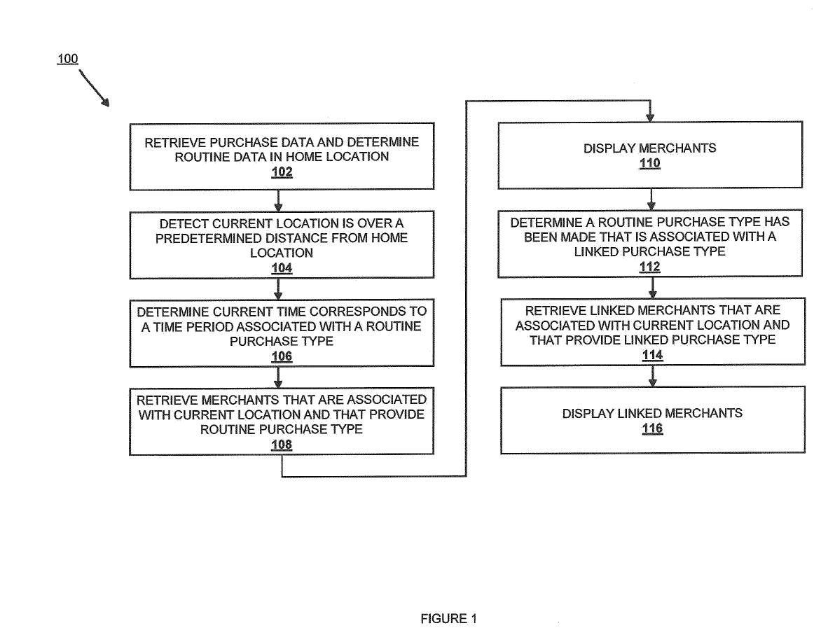

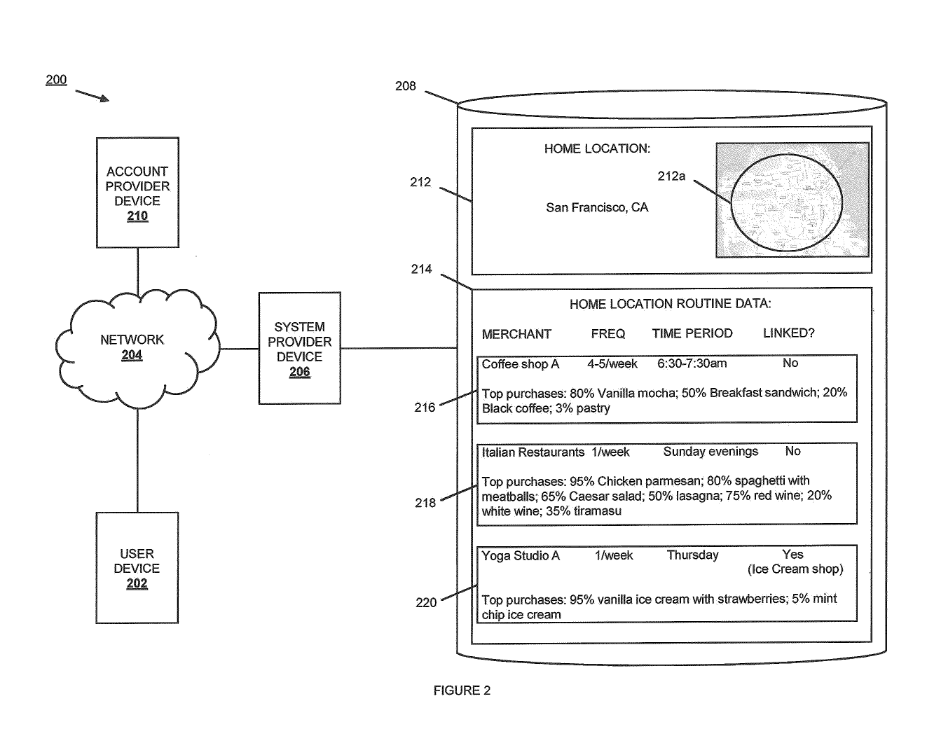

Referring now to FIGS. 1 and 2, an embodiment of a method 100 for providing routine suggestions is illustrated. In an embodiment, a user may be provided a user account by a payment service provider, and that user account will be linked to one or more financial accounts of the user that are provided by account providers. The user may make purchases from merchants using the user account, and those purchases are funded using one of the financial accounts. Thus, in some embodiments, the payment service provider may be the routine suggestion system provider. However, in other embodiments, the routine suggestion system may be provided by an account provider that provides a financial account to the user, a third party system provider that retrieves purchase data from user accounts/financial accounts, and/or a user device.

The method 100 begins at block 102 where purchase data is retrieved and routine data in a home location is determined. Referring now to FIG. 2, an embodiment of a routine suggestion system 200 is illustrated. A user in the routine suggestion system 200 may include a user device 202 that is connected to a network 204 such as, for example, the Internet. A system provider device 206 is connected to the network 204 as well as to a database 208. While the system provider device 206 is illustrated as directly connected to the database 208, the system provider device 206 may be connected to the database 208 through the network 204 while remaining within the scope of the present disclosure. In an embodiment, at block 102 of the method 100, the user may make purchases from merchants using the user device 202 and/or payment devices such as, for example, credit cards, check cards, and/or other payment devices known in the art. For example, the user device 202 may include a mobile phone, and the mobile phone may include a payment application or other payment functionality that allows the user to make payments to merchants via the user device 202. As discussed above, the user may use a user account provided by a payment service provider in order to make purchases from merchants that are funded by one or more financial accounts provided by the payment service provider and/or accounts providers. In another example, the user may present a payment card linked to a financial account provided by the payment service provider and/or accounts providers in order to make purchases from merchants.

Purchase data related to the purchases made using the user device 202 and or payments cards at block 102 of the method 100 may be stored in a database. For example, when the system provider device 206 is operated by a system provider that provides the financial account used by the user to make purchases, purchase data may be stored by the system provider device 206 in the database 208. In another example, purchase data may be stored by an account provider device 210 in a database (not illustrated), and the system provider device 206 may then periodically retrieve that purchase data and store that purchase data in the database 208. In another embodiment, the user device 202 may be the system provider device and may retrieve and store the purchase data from financial institutions of the user. Thus, in some embodiments, the database 208 may be located in the user device 202.

Purchase data related to purchases made by a user may be associated with a home location. In an embodiment, a user may define a home location where the user typically makes purchases (e.g., the location in which the user lives or spends a majority of their time), and that home location may then be saved as home location data 212 in the database 208. In the example illustrated in FIG. 2, the home location data corresponds to an area 212a in San Francisco, Calif. The user may define the home location by selecting the area 212a on a map, providing a home address and a distance from that home address within which purchases will be associated with the home location, providing a city (e.g., San Francisco, Calif.) in which purchases will be associated with the home location, and/or performing a variety of other home location designation actions known in the art. In another embodiment, purchase data may be analyzed to determine a home location. For example, the system provider device may review all purchase data retrieved at block 102 of the method 100, and determine an area within which over a predetermined percentage of purchases are made. In the example illustrated in FIG. 2, the purchase data associated with the user may have been analyzed (e.g., purchases made with the user device 202 that are associated with a GPS location, credit card purchases to a merchant associated with a merchant address, etc.) and determined to include 85% purchases made within the area 212a in San Francisco, Calif. While a few examples of the determination of a home location for a user have been described, one of skill in the art will recognize that a variety of other methods may be used to determine a home location where a user makes the majority of their purchases.

At block 102 of the method 100, the retrieved purchase data that is associated with the home location may then be analyzed to determine routine data in the home location. In an embodiment, the purchase data associated with the home location is analyzed to determine one or more routine purchase types that that are each associated with reoccurring time periods. For example, the purchase data associated with the home location may be analyzed to determine purchases from the same or similar merchant (e.g., a particular coffee shop, a plurality of similar coffee shops, a particular restaurant, a plurality of similar restaurants, etc.) that reoccur (e.g., that are made daily, weekly, monthly, etc.) In another example, the purchase data associated with the home location may be analyzed to determine purchases of the same or similar items (e.g., coffee, a type of food, etc.) that reoccur (e.g., that are made daily, weekly, monthly, etc.) For example, a routine purchase type may be determined when a plurality of purchases for a particular item type have been made at a plurality of merchants associated with the home location during a reoccurring time period. The analysis of the purchase data associated with the home location at block 102 of the method 100 results in the determination of routine data for the home location that details reoccurring purchases by the user from similar merchants and/or of similar items.

Furthermore, purchase data may include details of each purchase, and those details may be included in the routine data for the home location. For example, routine data for the home location may include reoccurring purchases made from a particular merchant or similar merchants, along with details about what item, items, service, or services are commonly purchased from the particular merchant or similar merchants.

The analysis of the purchase data at block 102 of the method 100 may also include the determination of linked purchase types that are associated with routine purchase types. As discussed above, the purchase data associated with the home location is analyzed to determine one or more routine purchase types that that are each associated with reoccurring time periods. For each routine purchase type, the system provider device 206 may analyze the purchase data to determine whether a linked purchase is commonly made following the routine purchase type. In an embodiment, a user may make reoccurring purchases from a particular merchant, from similar merchants, or of similar items, and those reoccurring purchases may often be followed by a linked purchase. For example, the system provide device 206 may analyze the purchase data to determine a routine purchase type that involves a particular merchant during a reoccurring time period is followed 65% of the time by a linked purchase that may be from a different particular merchant, similar merchants, or of a particular or similar item, and that linked purchase type may be associated with the routine purchase type in the database 208.

Examples of routine purchase types determined from the analysis of the purchase data at block 102 of the method 100 are illustrated in FIG. 2. In the illustrated embodiment, a plurality of home location routine data 214 is categorized by a merchant, a frequency, a time period, and whether that routine purchase type is associated with a linked purchase type. However, routine purchase data may be categorized by and/or include a variety of other information known in the art that is associated with purchase data without departing from the scope of the present disclosure.

In the illustrated embodiment, the home location routine data 214 includes a routine purchase type 216 that was determined from the purchase data and that details purchases made from a particular merchant (“Coffee Shop A”) that reoccur at a particular time period (between 6:30 and 7:30 am) multiple times per week (4-5 time per week). The routine purchase type 216 is not associated with a linked purchase, but is associated with purchase details that detail the types of purchases made from Coffee Shop A (e.g., a vanilla mocha 80% of the time, a breakfast sandwich 50% of the time, a black coffee 20% of the time, and a pastry 3% of the time.) Thus, the user may purchase coffee each weekday morning in their home location from the same coffee shop, and the routine data will include the routine purchase type 216 that indicates that the user makes this reoccurring purchase when in their home location. As discussed above, rather than including purchases from a particular merchant, the routine purchase type 216 may be associated with purchases from any of a variety of coffee shops, or coffee purchases from anywhere (e.g., the purchase data may indicate that the user purchases a vanilla mocha from a variety of merchants during the time period and at the frequency detailed in the routine purchase type 216.)

In the illustrated embodiment, the home location routine data 214 also includes a routine purchase type 218 that was determined from the purchase data and that details purchases made from similar merchants (“Italian restaurants”) that reoccur at a particular time period (Sunday evenings) once per week. The routine purchase type 218 is not associated with a linked purchase, but is associated with purchase details that detail the types of purchases made when at Italian restaurants (e.g., chicken parmesan 95% of the time, spaghetti with meatballs 80% of the time, Caesar salad 65% of the time, lasagna 50% of the time, red wine 75% of the time, white wine 20% of the time, and tiramisu 35% of the time.) Thus, the user may dine at an Italian restaurant with their family each Sunday night, and the routine data will include the routine purchase type 218 that indicates that the user makes this reoccurring purchase when in their home location. As discussed above, rather than including purchases from similar merchants, the routine purchase type 218 may be associated with purchases from a specific Italian restaurant, or Italian food purchases from anywhere.

In the illustrated embodiment, the home location routine data 214 also includes a routine purchase type 220 that was determined from the purchase data and that details purchases made from a particular merchant (“Yoga Studio A”) that reoccurs at a particular time period (Thursday) once per week. The routine purchase type 220 is associated with a linked purchase from similar merchants (“Ice Cream shop”), and is associated with purchase details that detail the types of purchases made when at the Ice Cream shop (e.g., vanilla ice cream with strawberries 95% of the time, mint chip ice cream 5% of the time.) Thus, the user may attend a yoga class on Thursdays, and may often follow that yoga class with ice cream at any of a plurality of ice cream shops, and the routine data will include the routine purchase type 220 that indicates that the user makes these linked, reoccurring purchases when in their home location. As discussed above, rather than including purchases from a particular merchant, the routine purchase type 220 may be associated with purchases from any of a plurality of yoga studios, and with a particular ice cream shop.

While a plurality of routine purchase types have been described above, one of skill in the art will recognize that a variety of routine purchase types may be determined using purchase data that will fall within the scope of the present disclosure. Furthermore, while the routine data is discussed above as being determined from purchase data associated with the home location, in some embodiments, purchase data associated with any location may be used to determine routine data (e.g., a user's reoccurring purchases in any locations of the same type of items, from the same types of merchants, and/or from particular merchants, may be used to determine the routine purchase types discussed herein.)

Referring back to FIG. 1, the method 100 then proceeds to block 104 where a current location is detected and determined to be over a predetermined distance from the home location. In an embodiment, the user device 202 may include a routine suggestion application or other routine suggestion engine that, when started on the user device 202, automatically retrieves a current location of the user device 202 using a location determination device (e.g, a Global Positioning System (GPS)) in the user device 202. In other embodiments, the routine suggestion application or other routine suggestion engine may operate “in the background” of the user device 202 to periodically check the current location of the user device 202. Upon determination of the current location, the routine suggestion application may determine whether the current location is further than a predetermined distance from the home location. In an embodiment, the predetermined distance may be a default distance in the routine suggestion application (e.g., 100 miles). In other embodiments, the user may set the predetermined distance to a desired distance. In some embodiments, the predetermined distance may operate to confine use of the method 100 to states other than a home state of the user, while in other embodiments, the predetermined distance may operate to provide the method 100 in neighborhoods other than the home neighborhood of the user. In the examples provided below, the current location is Austin, Tex., which is in a different state than the illustrated home location of San Francisco, Calif. However, if the user's home location is in the Nob Hill neighborhood in San Francisco, Calif., the user may set the predetermined distance such that the method 100 is performed in the Noe Valley neighborhood San Francisco, Calif.

When the current location of the user device 202 is determined to over the predetermined distance from the home location, the method 100 then proceeds to block 106 where a current time is determined to correspond to a time period associated with a routine purchase type. In an embodiment, when the current location of the user device 202 is more than the predetermined distance from the home location, the routine suggestion application in the user device 202 may continuously or periodically determine whether a current time is within a predetermined time of any of the time periods associated with the routine purchase types in the database 208. For example, when the current time is within 30 minutes, 1 day, or other time amount of a time period associated with a routine purchase type, the routine suggestion application may determine that the current time corresponds to a time period associated with a routine purchase type. In another example, when the current time falls within a time period associated with a routine purchase type, the routine suggestion application may determine that the current time corresponds to a time period associated with a routine purchase type. The predetermined time may be selected based on a number of factors including, for example, user calendar data that indicates how long a user will be in the current location that is greater than the predetermined distance from the home location. For example, a user calendar may include data that indicates that the user will be in the current location, which is greater than the predetermined distance from the home location, for a week. In such a situation, the routine suggestion application may retrieve each routine purchase type that is associated with that week and provide merchants (discussed below) for those routine purchase types immediately (i.e., the predetermined time may be a week when the user calendar data indicates that the user will be in that current location for a week.)

When the current location of the user device 202 is determined to be over the predetermined distance from the home location, and the current time corresponds to a time period associated with a routine purchase type, the method 100 proceeds to block 108 where merchants are retrieved that are associated with the current location and that provide the routine purchase type. In an embodiment, in response to determining that the current time corresponds to a time period associated with a routine purchase type, the routine suggestion application on the user device 202 may use the routine purchase type and the current location to search (e.g., over a network) a database of merchants in the current location that provide the routine purchase type. For example, if the routine purchase type includes a particular merchant, the routine suggestion application may access, over the network 204, a database of merchants in the current location to see if it includes the particular merchant (e.g., a franchisee) or similar merchants. In another example, if the routine purchase type includes a type of merchant, the routine suggestion application may access, over the network 204, a database of merchants in the current location to see if it includes similar merchants (e.g., the same type of merchant as the particular merchant.) In another example, if the routine purchase type includes an item type, the routine suggestion application may access, over the network 204, a database of merchants in the current location to see if it includes merchants that sell that item. Determination of whether a merchant sells an item or provides a service may be made by searching user reviews for that merchant to determine whether those reviews include mentioned of that item or service, searching online menus provided by that merchant, accessing a merchant database of that merchant that details the items or services for sale, searching other user's purchase histories at that merchant for those items or services, and/or using a variety of other items or service determination methods known in the art.

In an embodiment, merchants retrieved at block 108 may be filtered using the purchase details that are associated with the routine purchase type. For example, the routine purchase type may be a reoccurring purchase at a coffee shop in the home location, and a plurality of coffee shop merchants associated with the current location may be retrieved. Those coffee shop merchants may then be filtered by the item(s) that the user typically purchases at the coffee shop in the home location (e.g., the vanilla mocha in the illustrated embodiment discussed above) by determining which of the retrieved coffee shop merchants in the current location serve those item(s). In one example, the routine purchase type may include an item or items that are associated with a majority of purchases that make up the routine purchase type, and the merchants may be filtered such that only merchants that provide that item or items are displayed at block 110 of the method 100, discussed below. When a plurality of purchase details are associated with the routine purchase type, retrieved merchants that provide more of those purchase details (e.g., items, services, etc.) may be ranked higher than retrieved merchants that do not.

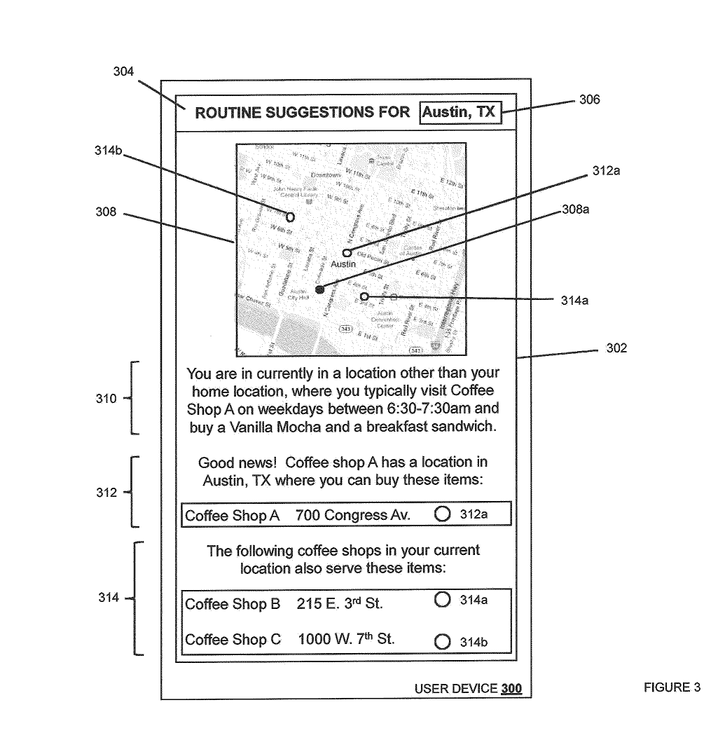

Referring now to FIGS. 1, 2, 3, 4, and 5, the method 100 then proceeds to block 110 where merchants are displayed to the user. Following retrieval of the merchants at block 108 of the method 100, the routine suggestion application on the user device 202 may display those merchants on a display device of the user device 202. FIGS. 3, 4, and 5 below illustrate specific examples of the display of merchants at block 110 of the method 100 following blocks 102, 104, 106, and 108. However, a wide variety of modifications to those examples are envisioned as falling within the scope of the present disclosure.

FIG. 3 illustrates an embodiment of a user device 300 including a display device 302. The display device 302 is displaying a routine suggestion screen 304 for a current location 306 (e.g., “Austin, Tex.”) that is a predetermined distance from a home location, as discussed above. The routine suggestion screen 304 includes a current location map 308 that provides a map of the current location determined at block 104, along with a user indicator 308a that indicates to the user their current location relative to the current location map 308. The routine suggestion screen 304 also includes a routine purchase type indicator 310 that details the routine purchase type associated with the current time determined at block 106. In the illustrated example, the routine purchase type indicator 310 is indicating to the user that, when in their home location, they typically visit Coffee Shop A on weekdays between 6:30-7:30 am and purchase a vanilla mocha and a breakfast sandwich (e.g., items associated with a majority of the purchases in the routine purchase type.)

The routine suggestion screen 304 also includes a first routine purchase suggestion section 312 that details a merchant in the current location that provides the routine purchase type. In the illustrated example, the routine suggestion section 312 has been provided after the routine suggestion application determined that the particular merchant associated with the routine purchase type is located in the current location (e.g., the merchant in the routine suggestion section 312 may be a franchise location related to the particular merchant frequented by the user in the home location.) The routine suggestion section 312 also includes a merchant identifier 312a for the merchant that is displayed on the map 308 to allow the user to determine directions to that merchant (e.g., relative to the user indicator 308a.) The routine suggestion screen 304 also includes a second routine purchase suggestion section 314 that details a plurality of merchants in the current location that provide the routine purchase type. In the illustrated example, the routine suggestion section 314 has been provided after the routine suggestion application has determined that a plurality of similar merchants associated with the routine purchase type are located in the current location (e.g., the merchants in the routine suggestion section 314 are coffee shops in the current location, and may provide items typically purchased by the user according to the routine purchase type.) The routine suggestion section 314 also includes merchant identifiers 314a and 314b for the merchants that are displayed on the map 308 to allow the user to determine directions to those merchants (e.g., relative to the user indicator 308a.)

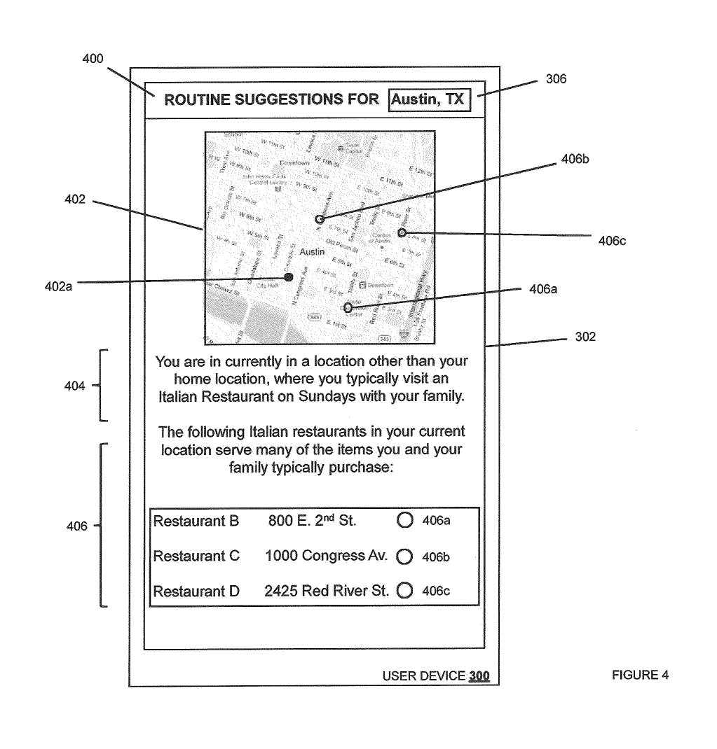

FIG. 4 illustrates an embodiment of the user device 300 with the display device 302 displaying a routine suggestion screen 400 for the current location 306 (e.g., “Austin, Tex.”). The routine suggestion screen 400 includes a current location map 402 that provides a map of the current location determined at block 104, along with a user indicator 402a that indicates to the user their current location relative to the current location map 402. The routine suggestion screen 400 also includes a routine purchase type indicator 404 that details the routine purchase type associated with the current time determined at block 106. In the illustrated example, the routine purchase type indicator 404 is indicating to the user that, when in their home location, they typically visit an Italian restaurant on Sundays with their family (in an embodiment, purchase data may be analyzed to determine that the user visits the Italian restaurant with their family based on, for example, an amount of food ordered, a type of food ordered, etc.)

The routine suggestion screen 400 also includes a routine purchase suggestion section 406 that details merchants in the current location that provide the routine purchase type. In the illustrated example, the routine suggestion section 406 has been provided after the routine suggestion application has determined that a plurality of similar merchants associated with the routine purchase type are located in the current location (e.g., the merchants in the routine suggestion section 406 are Italian restaurants in the current location, and may be filtered and/or ranked by items typically purchased by the user according to the routine purchase type.) The routine suggestion section 406 also includes merchant identifiers 406a, 406b, and 406c for the merchants that are displayed on the map 402 to allow the user to determine directions to those merchants (e.g., relative to the user indicator 402a.)

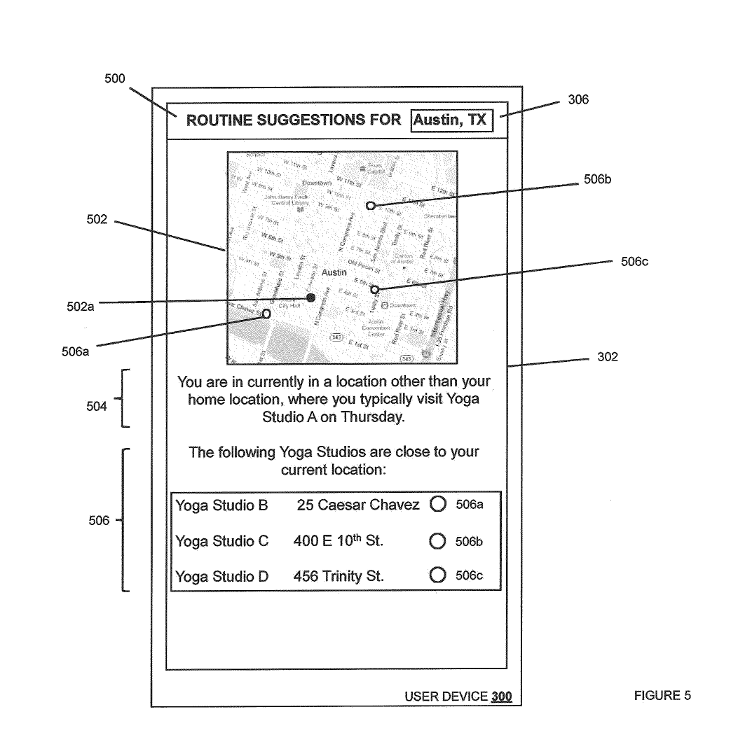

FIG. 5 illustrates an embodiment of the user device 300 with the display device 302 displaying a routine suggestion screen 500 for the current location 306 (e.g., “Austin, Tex.”). The routine suggestion screen 500 includes a current location map 502 that provides a map of the current location determined at block 104, along with a user indicator 502a that indicates to the user their current location relative to the current location map 502. The routine suggestion screen 500 also includes a routine purchase type indicator 504 that details the routine purchase type associated with the current time determined at block 106. In the illustrated example, the routine purchase type indicator 504 is indicating to the user that they typically visit Yoga Studio A on Thursday.

The routine suggestion screen 500 also includes a routine purchase suggestion section 506 that details merchants in the current location that provide the routine purchase type. In the illustrated example, the routine suggestion section 506 has been provided after the routine suggestion application has determined that a plurality of similar merchants associated with the routine purchase type are located in the current location (e.g., the merchants in the routine suggestion section 506 are yoga studios in the current location.) The routine suggestion section 506 also includes merchant identifiers 506a, 506b, and 506c for the merchants that are displayed on the map 502 to allow the user to determine directions to those merchants (e.g., relative to the user indicator 502a.)

Thus, when the user travels to a location away from their home location, that user may quickly and easily continue to make routine purchases because the systems and methods of the present disclosure learn their routine purchases in the home location and automatically display merchants at which the routine purchases may be made in the location away from the home location.

Following the display of the merchants at block 110, the method 100 may proceed to block 112 where it is determined that a routine purchase type has been made that is associated with a linked purchase type. A user may use the display of merchants at block 110 to select a merchant for making the routine purchase type provided by that merchant, and at block 112 the routine suggestion application may determine that such a routine purchase type has been made. In an embodiment, the routine purchase type may be made using the user device 202, and the routine suggestion application may detect that use and purchase at block 112. In another embodiment, the routine purchase type may be made using another payment device such as a credit card, and details about that transaction may be received by and/or retrieved by the routine suggestion application at block 112. In another embodiment, the routine suggestion application may detect the user is located at the merchant for a predetermined amount of time and, in response, the routine suggestion application may determine that the user has made the routine purchase type (e.g., the routine suggestion application may determine that the user is located at Yoga Studio B, illustrated in FIG. 5, for more than 30 minutes and, in response, determine that the user has made a routine purchase type of a yoga class.)

In response to determining that a routine purchase type has been made, the routine suggestion application may determine (e.g., through communication over the network 204 with the system provider device 206, retrieved from a database in the user device 202, etc.) that the routine purchase is associated with a linked purchase type in the database 208. For example, in the embodiment illustrated in FIGS. 2 and 5, the user may make a routine purchase type from a yoga studio, and the routine suggestion application will determine that the routine purchase type 220 includes a linked purchase type that includes a purchase at an ice cream shop that often follows a purchase of a yoga class.

The method 100 then proceeds to block 114 where linked merchants are retrieved that are associated with the current location and that provide the linked purchase type. In an embodiment, in response to determining that the routine purchase type has been made and is associated with a linked purchase type, the routine suggestion application on the user device 202 may use the linked purchase type and the current location to search a database of merchants in the current location that provide the linked purchase type (e.g., “linked merchants”.) For example, if the linked purchase type includes a particular merchant, the routine suggestion application may access (over the network 204, in the user device 202, etc.) a database of merchants in the current location to see if it includes the particular merchant (e.g., a franchisee) or similar merchants (e.g., the same type of merchant as the particular merchant frequented in the home location.) In another example, if the linked purchase type includes an item type, the routine suggestion application may access (over the network 204, in the user device 202, etc.) a database of merchants in the current location to see if it includes merchants that sell that item.

In an embodiment, linked merchants retrieved at block 114 may be filtered using the purchase details that are associated with the linked purchase type. For example, the linked purchase type may be a reoccurring purchase, which often follows a purchase at a particular yoga studio in the home location, at an ice cream shop in the home location, and a plurality of ice cream shop merchants associated with the current location may be retrieved. Those ice cream shop merchants may then be filtered by the item(s) that the user typically purchases at the ice cream shop in the home location (e.g., the vanilla ice cream with strawberries in the illustrated embodiment discussed above) by determining which of the retrieved ice cream shop merchants in the current location serve those item(s). In one example, the linked purchase type may include an item or items that are associated with a majority of purchases that make up the linked purchase type, and the merchants may be filtered such that only merchants that provide that item or items are displayed at block 110 of the method 100, discussed below.

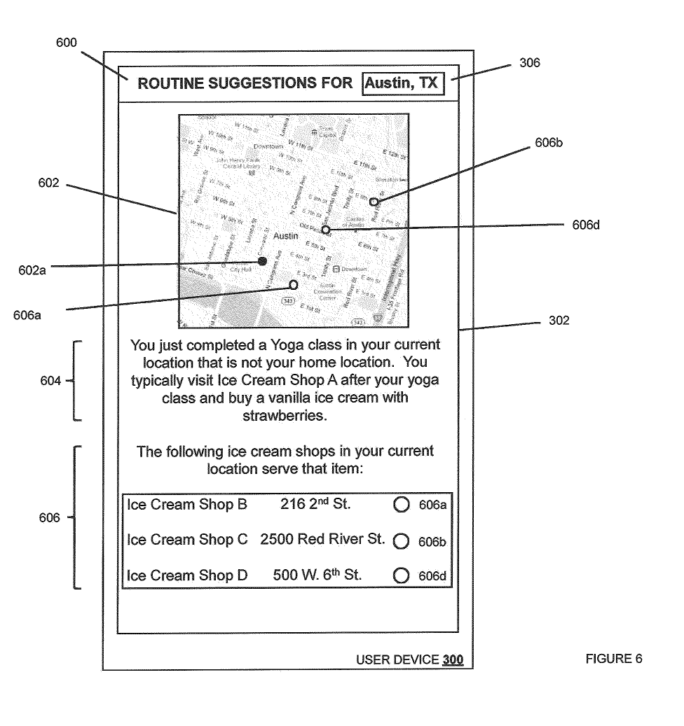

Referring now to FIGS. 1, and 6, the method 100 then proceeds to block 116 where linked merchants are displayed to the user. Following retrieval of the linked merchants at block 114 of the method 100, the routine suggestion application may display those linked merchants on a display device of the user device 202. FIG. 6, with reference to FIG. 5 discussed above, illustrates a specific example of the display of linked merchants at block 116 following blocks 112 and 114 of the method 100. However, a wide variety of modifications to that example are envisioned as falling within the scope of the present disclosure

FIG. 6 illustrates an embodiment of the user device 300 with the display device 302 displaying a routine suggestion screen 600 for the current location 306 (e.g., “Austin, Tex.”) following the determination that a purchase was made at a merchant displayed on the routine suggestion screen 500, discussed above with reference to FIG. 5. The routine suggestion screen 600 includes a current location map 602 that provides a map of the current location determined at block 104, along with a user indicator 602a that indicates to the user their current location relative the current location map 602. The routine suggestion screen 600 also includes a linked purchase type indicator 604 that details the linked purchase type determined at block 112. In the illustrated example, the linked purchase type indicator 604 is indicating to the user that, when in the home location, they typically visit Ice Cream Shop A after attending a yoga class and purchase a vanilla ice cream with strawberries (e.g., an item associated with a majority of the purchases in the routine purchase type.)

The routine suggestion screen 600 also includes a linked purchase suggestion section 606 that details merchants in the current location that provide the linked purchase type. In the illustrated example, the linked purchase suggestion section 606 has been provided after the routine suggestion application has determined that a plurality of similar merchants associated with the linked purchase type are located in the current location (e.g., the merchants in the routine suggestion section 606 are ice cream shops in the current location.) The linked purchase suggestion section 606 also includes merchant identifiers 606a, 606b, and 606c for the merchants that are displayed on the map 602 to allow the user to determine directions to those merchants (e.g., relative to the user indicator 602a.) In different embodiments, any number of linked purchase types may be associated with a routine purchase type or other linked purchase types.

Thus, systems and methods have been described that provide routine suggestions to a user by first determining routing purchase types of the user that include reoccurring purchases that occur during reoccurring time periods in a home location. When the user travels to a different location that is away from the home location, the systems and methods discussed herein may provide the locations of merchants in that different location that provide the routine purchase type so that the user may continue to make those routine purchase types during their usual time periods. Routine purchase types may be associated with any number of linked purchase types that include purchases that are often made in association with a routine purchase type, and following the determination that a routine purchase type has been made, the location of merchants that provide the linked purchase type may be provided to the user. Thus, a user's routine may be uninterrupted when that user is away from their usual location through the learning of those routines and the suggestions of merchants in different locations at which those routines may be conducted.

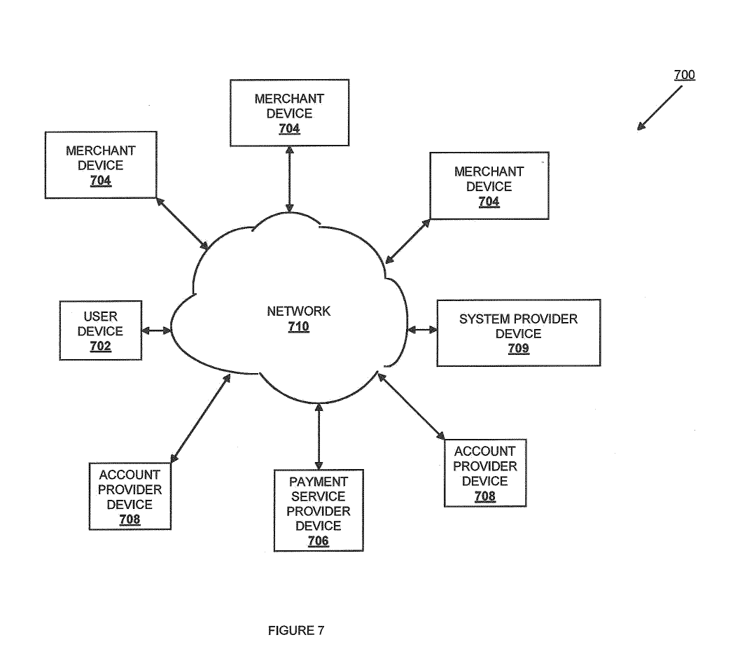

Referring now to FIG. 7, an embodiment of a network-based system 700 for implementing one or more processes described herein is illustrated. As shown, network-based system 700 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 7 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 700 illustrated in FIG. 7 includes a plurality of user devices 702, a plurality of merchant devices 704, a payment service provider device 706, a plurality of account holder devices 608, and/or a system provider device 709 in communication over a network 710. Any of the user devices 702 may be the user device 202 or 300, discussed above. The merchant devices 704 may be merchants devices operated by the merchants discussed above. The payment service provider device 706 may be payment service provider devices operated by a payment service provider such as, for example, PayPal Inc. of San Jose, Calif. The account provider devices 708 may be account provider devices operated by the account providers discussed above such as, for example, credit card account providers, bank account providers, savings account providers, and a variety of other account providers known in the art. The system provider device 709 may be operated by any third party system provider other than the payment service provider or account provider.

The user device 702, merchant devices 704, payment service provider device 706, account provider devices 708, and/or system provider device 709 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 700, and/or accessible over the network 710.

The network 710 may be implemented as a single network or a combination of multiple networks. For example, in various embodiments, the network 710 may include the Internet and/or one or more intranets, landline networks, wireless networks, and/or other appropriate types of networks.

The user device 702 may be implemented using any appropriate combination of hardware and/or software configured for wired and/or wireless communication over network 710. For example, in one embodiment, the user device 702 may be implemented as a personal computer of a user in communication with the Internet. In other embodiments, the user device 702 may be a smart phone, personal digital assistant (PDA), laptop computer, and/or other types of computing devices.

The user device 702 may include one or more browser applications which may be used, for example, to provide a convenient interface to permit the user to browse information available over the network 710. For example, in one embodiment, the browser application may be implemented as a web browser configured to view information available over the Internet.

The user device 702 may also include one or more toolbar applications which may be used, for example, to provide user-side processing for performing desired tasks in response to operations selected by the user. In one embodiment, the toolbar application may display a user interface in connection with the browser application.

The user device 702 may further include other applications as may be desired in particular embodiments to provide desired features to the user device 702. In particular, the other applications may include a payment application for payments assisted by a payment service provider through the payment service provider device 706. The other applications may also include security applications for implementing user-side security features, programmatic user applications for interfacing with appropriate application programming interfaces (APIs) over the network 710, or other types of applications. Email and/or text applications may also be included, which allow the user to send and receive emails and/or text messages through the network 710. The user device 702 includes one or more user and/or device identifiers which may be implemented, for example, as operating system registry entries, cookies associated with the browser application, identifiers associated with hardware of the user device 702, or other appropriate identifiers, such as a phone number. In one embodiment, the user identifier may be used by the payment service provider device 706 and/or account provider device 708 and/or system provider device 709 to associate the user with a particular account or database entries as further described herein.

The merchant device 704 may be maintained, for example, by a conventional or on-line merchant, conventional or digital goods seller, individual seller, and/or application developer offering various products and/or services in exchange for payment to be received conventionally or over the network 710. In this regard, the merchant device 704 may include a database identifying available products and/or services (e.g., collectively referred to as items) which may be made available for viewing and purchase by the user.

The merchant device 704 also includes a checkout application which may be configured to facilitate the purchase by the payer of items. The checkout application may be configured to accept payment information from the user through the user device 702, the account provider through the account provider device 708, from the payment service provider through the payment service provider device 706, and/or the system provider through the system provider device 709 over the network 710.

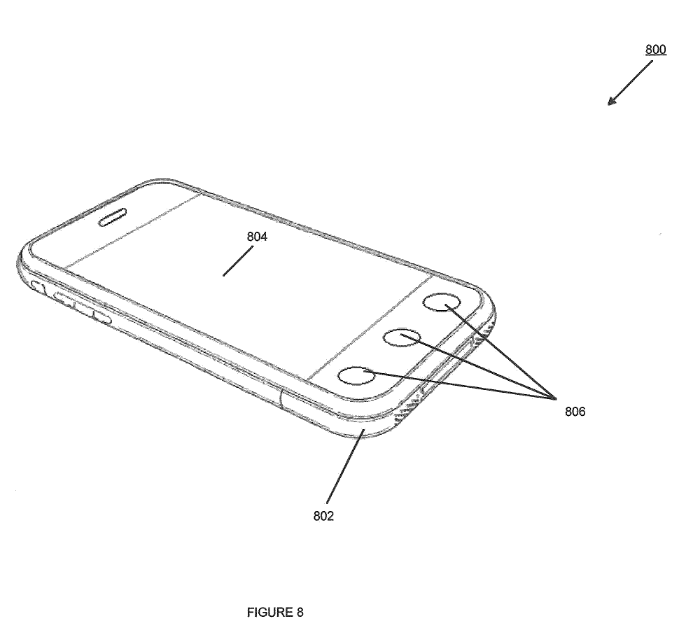

Referring now to FIG. 8, an embodiment of a user device 800 is illustrated. The user device 800 may be the user devices 202, 300, and/or 702, discussed above. The user device 800 includes a chassis 802 having a display 804 and an input device including the display 804 and a plurality of input buttons 806. One of skill in the art will recognize that the user device 800 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

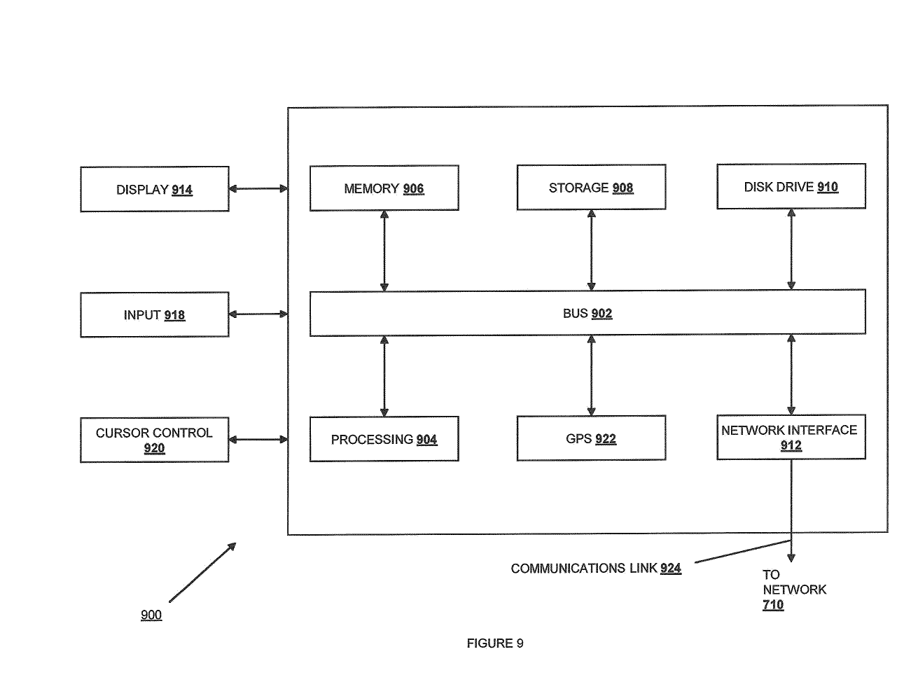

Referring now to FIG. 9, an embodiment of a computer system 900 suitable for implementing, for example, the user device 202, the user device 300, the user device 702, the user device 800, the merchant devices 704, the payment service provider device 706, the account provider device 708, and/or the system provider device 709, is illustrated. It should be appreciated that other devices utilized by user, merchants, payment service providers, account providers, and/or system provider devices in the payment system discussed above may be implemented as the computer system 900 in a manner as follows.

In accordance with various embodiments of the present disclosure, computer system 900, such as a personal computer and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 918 (e.g., keyboard, keypad, or virtual keyboard), a cursor control component 920 (e.g., mouse, pointer, or trackball), and/or a location determination component 922 (e.g., a Global Positioning System (GPS) device as illustrated, a cell tower triangulation device, and/or a variety of other location determination devices known in the art.) In one implementation, the disk drive component 910 may comprise a database having one or more disk drive components.

In accordance with embodiments of the present disclosure, the computer system 900 performs specific operations by the processor 904 executing one or more sequences of instructions contained in the memory component 906, such as described herein with respect to the user devices 202, 300, 702, and 800, the merchant devices 704, the payment service provider device 706, the account provider device(s) 708, and/or the system provider device 709. Such instructions may be read into the system memory component 906 from another computer readable medium, such as the static storage component 908 or the disk drive component 910. In other embodiments, hard-wired circuitry may be used in place of or in combination with software instructions to implement the present disclosure.

Logic may be encoded in a computer readable medium, which may refer to any medium that participates in providing instructions to the processor 904 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 910, volatile media includes dynamic memory, such as the system memory component 906, and transmission media includes coaxial cables, copper wire, and fiber optics, including wires that comprise the bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 900. In various other embodiments of the present disclosure, a plurality of the computer systems 900 coupled by a communication link 924 to the network 710 (e.g., such as a LAN, WLAN, PTSN, and/or various other wired or wireless networks, including telecommunications, mobile, and cellular phone networks) may perform instruction sequences to practice the present disclosure in coordination with one another.

The computer system 900 may transmit and receive messages, data, information and instructions, including one or more programs (i.e., application code) through the communication link 924 and the network interface component 912. The network interface component 912 may include an antenna, either separate or integrated, to enable transmission and reception via the communication link 924. Received program code may be executed by processor 904 as received and/or stored in disk drive component 910 or some other non-volatile storage component for execution.

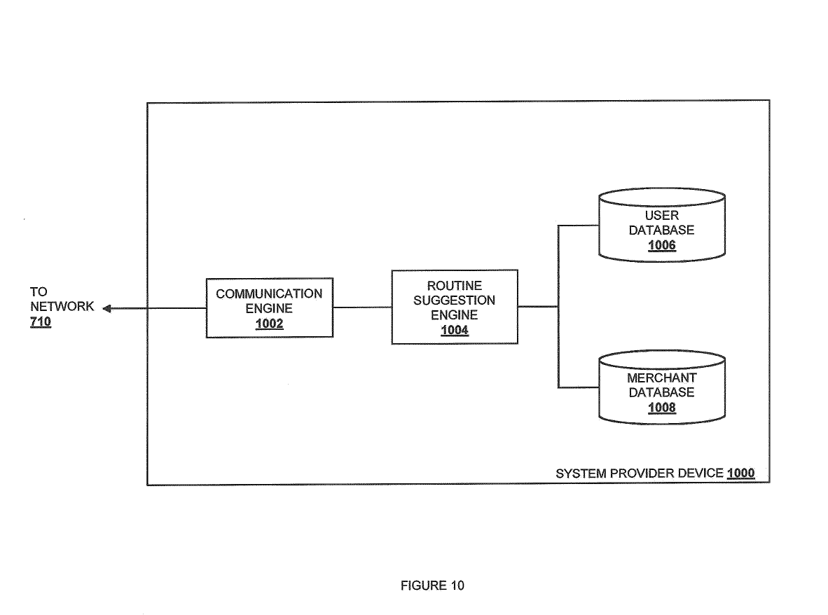

Referring now to FIG. 10, an embodiment of a user device/payment service provider device/account provider device/system provider device 1000 is illustrated. In an embodiment, the device 1000 may be the user devices 202, 300, 702, and 800, the payment service provider device 706, the account holder device 708, and/or the system provider device 709. The device 1000 includes a communication engine 1002 that is coupled to the network 710 and to a routine suggestion engine 1004 that is coupled to a user database 1006 and a merchant database 1008. The communication engine 1002 may be software or instructions stored on a computer-readable medium that allows the device 1000 to send and receive information over the network 710. The routine suggestion engine 1004 may be software or instructions stored on a computer-readable medium that allows the device 1000 to receive purchase data, determine routine data and store it in the user database 1006, detect a current location, determine that the current location is over a predetermined distance from a home location stored in the user database 1006, determine a current time, determine that a current time corresponds to a time period associated with a routine purchase type in the user database 1006, retrieve merchants associated with a current location that provide a routine purchase type from the merchant database 1008, display merchants, determine that a routine purchase type has been made that is associated with a linked purchase type in the user database 1006, retrieve linked merchants that are associated with the current location and that provide the linked purchase type from the merchant database 1008, display linked merchants, and provide any of the other functionality that is discussed herein. While the databases 1006 and 1008 have been illustrated as located in the device 1000, one of skill in the art will recognize that they may be connected to the routine suggestion engine 1004 through the network 110 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing routine data associated with a user, wherein the routine data includes a home location, a routine purchase type associated with the home location, and a time period associated with the routine purchase type;
one or more hardware processors coupled to the memory and operable to read instructions from the memory to perform the steps of:
determining that the user is in a current location that is over a predetermined distance from the home location;
determining that a current time corresponds to the time period associated with the routine purchase type;
retrieving at least one merchant that is associated with the current location and that provides the routine purchase type; and
displaying the at least one merchant on a display device.

2. The system of claim 1, wherein the non-transitory memory stores a plurality of purchases associated with the routine purchase type, and the one or more hardware processors are operable to read instructions from the memory to perform the steps of:
retrieving the plurality of purchases associated with the routine purchase type; and
filtering a plurality of merchants associated with the current location using the plurality of purchases to retrieve the at least one merchant that provides the routine purchase type by providing at least one item associated with a majority of the plurality of purchases.

3. The system of claim 1, wherein the routine purchase type includes a plurality of purchases made at a first merchant associated with the home location, and the time period includes a reoccurring time period in which the purchases were made.

4. The system of claim 1, wherein the non-transitory memory stores a linked purchase type associated with the routine purchase type, and the one or more hardware processors are operable to read instructions from the memory to perform the steps of:
determining that a purchase has been made from a merchant of the at least one merchant displayed on the display device;
retrieving at least one linked merchant that is associated with the current location and the linked purchase type; and
displaying the at least one linked merchant on a display device.

5. The system of claim 4, wherein the non-transitory memory stores a plurality of purchases associated with the linked purchase type, and the one or more hardware processors are operable to read instructions from the memory to perform the steps of:
retrieving the plurality of purchases associated with the linked purchase type; and
filtering a plurality of linked merchants associated with the current location using the plurality of purchases associated with the linked purchase type to retrieve the at least one linked merchant that provides the linked purchase type by providing at least one item associated with a majority of the plurality of purchases associated with the linked purchase type.

6. The system of claim 1, wherein the routine purchase type includes a plurality of purchases for the same item type made at a plurality of merchants associated with the home location, and the time period includes a reoccurring time period in which the purchases were made.

7. A method for providing routine suggestions, comprising:
determining that a user is in a current location that is over a predetermined distance from a home location associated with the user in a non-transitory memory;
determining that a current time corresponds to a time period associated with a routine purchase type that is associated with the home location in the non-transitory memory;
retrieving at least one merchant over a network that is associated with the current location and that provides the routine purchase type; and
displaying the at least one merchant on a display device.

8. The method of claim 7, further comprising:
retrieving a plurality of purchases associated with the routine purchase type; and
filtering a plurality of merchants associated with the current location using the plurality of purchases to retrieve the at least one merchant that provides the routine purchase type by providing at least one item associated with a majority of the plurality of purchases.

9. The method of claim 8, further comprising:
displaying the at least one item associated with the majority of the plurality of purchases on the display device.

10. The method of claim 7, wherein the routine purchase type includes a plurality of purchases made at a first merchant associated with the home location, and the time period includes a reoccurring time period in which the purchases were made.

11. The method of claim 7, further comprising:
determining that a purchase has been made from a merchant of the at least one merchant displayed on the display device;
retrieving at least one linked merchant that is associated with the current location and a linked purchase type that is associated with the routine purchase type in the non-transitory memory; and
displaying the at least one linked merchant on a display device.

12. The method of claim 11, further comprising:
retrieving a plurality of purchases associated with the linked purchase type; and
filtering a plurality of linked merchants associated with the current location using the plurality of purchases associated with the linked purchase type to retrieve the at least one linked merchant that provides the linked purchase type by providing at least one item associated with a majority of the plurality of purchases associated with the linked purchase type.

13. The method of claim 7, wherein the routine purchase type includes a plurality of purchases for the same item type made at a plurality of merchants associated with the home location, and the time period includes a reoccurring time period in which the purchases were made.

14. A non-transitory machine-readable medium comprising a plurality of machine-readable instructions which, when executed by one or more processors, are adapted to cause the one or more processors to perform a method comprising:
determining that a user is in a current location that is over a predetermined distance from a home location associated with the user in a non-transitory memory;
determining that a current time corresponds to a time period associated with a routine purchase type that is associated with the home location in the non-transitory memory;
retrieving at least one merchant over a network that is associated with the current location and that provides the routine purchase type; and
displaying the at least one merchant on a display device.

15. The non-transitory machine-readable medium of claim 14, wherein the method further comprises:
retrieving a plurality of purchases associated with the routine purchase type; and
filtering a plurality of merchants associated with the current location using the plurality of purchases to retrieve the at least one merchant that provides the routine purchase type by providing at least one item associated with a majority of the plurality of purchases.

16. The non-transitory machine-readable medium of claim 15, wherein the method further comprises:
displaying the at least one item associated with the majority of the plurality of purchases on the display device.

17. The non-transitory machine-readable medium of claim 14, wherein the routine purchase type includes a plurality of purchases made at a first merchant associated with the home location, and the time period includes a reoccurring time period in which the purchases were made.

18. The non-transitory machine-readable medium of claim 14, wherein the method further comprises:
determining that a purchase has been made from a merchant of the at least one merchant displayed on the display device;
retrieving at least one linked merchant that is associated with the current location and a linked purchase type that is associated with the routine purchase type in the non-transitory memory; and
displaying the at least one linked merchant on a display device.

19. The non-transitory machine-readable medium of claim 14, wherein the method further comprises:
retrieving a plurality of purchases associated with the linked purchase type; and
filtering a plurality of linked merchants associated with the current location using the plurality of purchases associated with the linked purchase type to retrieve the at least one linked merchant that provides the linked purchase type by providing at least one item associated with a majority of the plurality of purchases associated with the linked purchase type.

20. The non-transitory machine-readable medium of claim 14, wherein the routine purchase type includes a plurality of purchases for the same item type made at a plurality of merchants associated with the home location, and the time period includes a reoccurring time period in which the purchases were made.
